(19) United States
(12) Patent Application Publication
(10) Pub. No.: US 2010/0282241 A1
(43) Pub. Date: Nov. 11, 2010

(54) SOLAR COLLECTOR

(76) Inventor: Robert Massen, Ohningen (DE)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/741,477

(22) PCT Filed: Nov. 7, 2008
(86) PCT No.: PCT/EP08/09418

§ 371 Date: Jul. 26, 2010

(30) Foreign Application Priority Data
Nov. 11, 2007 (DE) 102007054124.6

(51) Int. Cl. F24J 2/46; B23P 15/00

(52) U.S. Cl. 126/569; 29/890.033

(57) ABSTRACT

A solar collector having an absorbent surface that only reflects a small fraction of the sunlight and, owing to selective reflection properties, simulates a two-dimensional surface or a three-dimensional spatial shape or creates a visual impression conveying contents.

### FIELD OF THE INVENTION

The invention relates to a solar collector.

### BACKGROUND OF THE INVENTION

Reducing energy consumption of private and public buildings by employing solar collectors that are mounted mainly on roofs and façades and comprise photovoltaic panels that convert solar energy into electric power and solar thermal panels that convert solar energy into heat, is a measure promoted on a global scale to reduce energy consumption.

Both photovoltaic cells and solar thermal panels through which a liquid flows are optimized for a best-possible absorption of sunlight. But this is tantamount to a minimum possible reflection since every reflected photon is lost in terms of conversion into electric power (in photovoltaics) or into heat (in solar thermal energy technology). Accordingly, these panels or solar collectors look dark black to dark blue and thus form interruptions that are impossible to overlook in the architecturally appearing structure of a roof covered with roof tiles, slate tablets or greenery.

By way of example, FIG. 1 shows, in a photograph reduced to a mere line drawing for printing-related reasons, a roof of a private home 10 covered with roof tiles and both with a thermal solar collector 12 and with a photovoltaic solar collector 14. The dark planar interruption of both the color and the structure of the roof tiles is visually highly disturbing and not really tolerable from an architectural design point of view.

There is no need for further explanation to illustrate the disturbance of the visual impression of such roofs more clearly, both with private and with public buildings and, even more extremely, in the case of historic buildings. As façade surfaces are also increasingly fitted with such systems, the aesthetic disturbance in the overall picture of settlements, industrial buildings, etc. increases. The consequence is that many buildings and practically all historic buildings, even if suitably located, cannot be equipped for solar energy generation technology, if only for reasons of conservation of historical monuments. Even in the case of large solar parks in the open, the panels are visually highly disturbing.

A number of approaches have already been made to reduce this disturbing aesthetic impression in roof design by a periodic arrangement of solar cells. For example, WO 2006/010261 A1 describes a periodic arrangement of smaller photovoltaic cells having a size and arrangement that, in a way, visually mimic at least the periodic arrangement of roof tiles. An adjustment to the color of the roof is provided here by an antireflective layer dyed with a particular color, but which cannot create an impression of three-dimensionality. In addition, such a dyeing is associated with a major reduction in the light absorbed.

DE 19739948 describes a photovoltaic roof tile in which small, specially shaped photovoltaic cells are embedded, so that at least the 3D shape of a roof tile is retained, but not its color impression.

WO 2004/079278 describes a spectrally operating procedure to provide solar cells with layers that are reflective in a narrow band on their entire surface, the layers giving the normally black cells a colored appearance while still passing the major part of the spectrum of the sunlight, thus reducing energy generation only insignificantly. A number of materials and coatings are described to achieve this purpose.

The aforementioned methods of photovoltaic power generation are expensive special solutions which greatly restrict efficiency and run contrary to the trend towards low-cost mass production of large, flat photovoltaic panels.

No economic approaches to the architectural design of solar thermal panels are known. Within the scope of the present application, we define the term “architectural design” as the sum of all physical measures to give a surface which, for the purpose of energy generation, does not reflect solar radiation a desired visual impression to a human observer. Here, the planar coloration is only one aspect, which often is not sufficient since a homogeneously colored surface is too simple for most design wishes. Architectural design therefore also requires graphical elements such as lines and graphically emphasized elements, textured surfaces, etc.

### SUMMARY OF THE INVENTION

There is therefore a great public and economic interest in designing thermal or photovoltaic solar collectors in such a way that, on the one hand, a desired visual impression is created and, on the other hand, the solar collectors can be mass-produced at low cost while the energetic efficiency is reduced as little as possible.

There is an interest in raising the acceptance of solar energy utilization by providing solar collectors which have a high efficiency and are still not perceived as being optically disturbing. As a result, solar collectors would also be made use of where they have, to date, been rejected as aesthetically unacceptable. A small loss in efficiency is thereby immediately compensated for.

This object is achieved in accordance with the invention by a solar collector having an absorbent surface that only reflects a small fraction of the sunlight and, owing to selective reflection properties, simulates one or more two-dimensional surfaces or three-dimensional spatial shapes or creates a visual impression conveying contents.

Only a small fraction of the sunlight is reflected, so that there is only a slight deterioration in efficiency. A small percentage of reflected light is sufficient for simulation of a two-dimensional surface or a three-dimensional spatial shape or for creating a visual impression conveying contents, because reflection is effected selectively. A simulated surface may be, for example, a façade wall with a particular color, even with a pattern inherent in the color, or edge limitations of slate tablets. A simulated three-dimensional spatial shape could be an imitation of the roof tiles surrounding the solar collector. A visual impression conveying contents may convey an advertising message, for example.

Depending on the criterion according to which the reflection is selected, only 1 to 10% of the incident sunlight is reflected, for instance; with an appropriate design and/or combination of different selections, preferably between 1 and 5%.

In a first embodiment, the absorbent surface reflects spectrally selectively.

Preferably, incident sunlight is reflected only in a selected narrow-band wavelength range or in selected narrow-band wavelength ranges which only have a width of about 5 to 15 nm, for example. Advantageously, the reflected wavelength bands are in the range of the highest perception of the human eye. The eye has three perception maxima. Typically, the maxima of these reflection bands are placed in the values established for the CIE standard observer:
BLUE=435.8 nm
GREEN=546.1 nm
RED=600.0 nm,
   which correspond to the maximum sensitivity of the human color vision system for the three primary colors, blue, green, red. A reflection may, of course, also be placed between the maxima for green and red, for instance, where the perception by both the green cones and the red cones is high. What is decisive in selecting the reflected wavelengths is that as little energy as possible should be reflected to achieve a desired visual effect.

Owing to the reflection being adjusted to human perceptiveness spectrally precisely and in a very narrow band, a desired visual impression can already be created by the reflection of a very small percentage of the incident sunlight; only a small fraction of the sunlight is reflected. The loss of energy caused by reflection remains small. The selection as to which rays are to be reflected is made on the spectral level.

The manufacture of coatings that reflect in a narrow band of the spectrum is known to a person of ordinary skill in the art of optical coating technology by the English term “narrow band partial reflective coatings”. Such coatings are offered by Red Optronics Company (www.optical-components.com), for example.

Preferably, the spectrally narrow-band reflection can be fully or partly assisted or formed by a fluorescence effective in the desired wavelength bands. In particular in black thermal collectors, which cannot exploit the UV portion of the sunlight, a selective fluorescence is able to make use of this unused energy of the spectrum in a visible reflection that can be employed for aesthetic design.

In a second embodiment, the absorbent surface reflects directionally selectively.

Preferably, incident sunlight is essentially not reflected into a first solid angle range and is reflected only into a second solid angle range which is smaller than the first solid angle range and essentially corresponds to that solid angle range at which the solar collector, when in an operative condition, is predominantly seen by a human observer.

The fact that the reflection is effected only into that solid angle range from which a human observer usually views the roof/the outer wall with the solar collectors is another reason why reflection of a very small percentage of the incident sunlight is sufficient; only a small fraction of the sunlight is reflected and, therefore, the loss of energy is low. The selection as to which rays are to be reflected is made on a spatial level.

The production of layers having a directionally selective behavior is known to a person skilled in the art of optical layers. The Merck company, of Darmstadt, Germany, for example, produces printable and sprayable pigments that reflect specific wavelengths into specific directions (“effect pigments”) (see, e.g., Dr. Christoph Schmidt, Merck KGaA, Darmstadt, “Der Lichtmanager: Farbstoffe and Pigmente in unserer Umgebung” (the light manager: dyestuffs and pigments in our surroundings)). The use of nanostructures likewise allows the manufacture of layers with a directionally selective reflection.

Nanostructures of this kind may also be applied using traditional printing technologies such as web printing, digital inkjet printing and the like, the nanoparticles orienting themselves on the substrate in a self-organized process from a vaporizing carrier liquid such that the resultant layer shows a particular angle of reflection for incident sunlight.

In a third embodiment, the absorbent surface reflects surface-selectively. The reflecting surfaces can graphically mimic the edges of roof tiles, for example, so that, in proportion to the absorbent surface, the reflective surface is only very small and only a small fraction of the sunlight is reflected.

The reflecting surfaces required for the desired optical impression are preferably interrupted such that a human observer does not perceive an interruption. This is possible to a greater or lesser degree, depending on the angle at which the solar collector is viewed. A human being unconsciously supplements to a high degree any interrupted surfaces and structures. As a result, the amount of radiation not available for energy conversion may be reduced; the efficiency thus increases. The interruption of the reflecting surface, which is not perceived by a human being, leads to an even smaller fraction of the sunlight being reflected.

All three aforementioned embodiments may be combined with each other as desired.

In a further configuration, the visual impression is adjusted to the surface that surrounds the solar collector after installation, that is, in the operative condition. According to another configuration, the absorbent solar collector surface may also be made use of for works of art or advertising space—always with an only very small reduction in efficiency since only a small percentage of the incident light is reflected.

The change in reflection properties is preferably achieved by printing, coating or texturing the solar collector surface. This allows a very cost-effective implementation, which is also suitable for mass-production.

The printing, coating or texturing may be performed, for example, on a glass plate provided to protect the solar collector. Also, a printed film may be provided which is applied on the absorbent surface of the solar collector.

It is known to a person skilled in the art of optical coatings that optical properties may also be controlled electrically. In the case of electrochromic glasses, for example, the transparency or the diffuse backscattering of light can be controlled by applying a voltage. When such glasses are combined with the above-described layers having a spectrally selective behavior or with a directionally selective reflection, the desired effects can be additionally controlled electrically. This is of interest, for example, to the design of solar collectors for advertising purposes.

The invention further provides a method of manufacturing solar collectors.

### BRIEF DESCRIPTION OF THE DRAWINGS

FIG. 1 shows the disturbing visual impression of photovoltaic and thermal solar collectors in the prior art, which interrupt the architectural appearance of the structure and color of a roof covered with roof tiles by a continuous dark surface;

FIG. 2 shows the spectral sensitivity curves of the human eye;

FIG. 3 shows the solid angle of the reflection required of a printed-on graphical pattern of imitated roof tiles on a photovoltaic roof panel, for this pattern to be visible to an observer from the street;

FIG. 4 illustrates more clearly the exploitation of the principle of human visual continuation of graphical patterns to reduce the total reflective surface.

### DESCRIPTION OF PREFERRED EMBODIMENTS

As already discussed with reference to FIG. 1, the architectural design of solar collectors can be based on the following object: it is intended to design the solar collector by appropriate surface processes so that it optically corresponds to the undisturbed roof tile pattern; for cost reasons, this is expediently carried out using a simple printing process at the end of the process of fabricating the entire solar collector and may only slightly impair the energetic efficiency. In particular with custom-made designs, a digital printing process such as inkjet printing is suitable. Other processes that produce patterns, such as texturing of the surface, coating with interference paints, nanostructures with wavelength-dependent reflection, etc. are known to a person skilled in the art of surface technology. For reasons of simplification, we present the idea of the invention primarily with reference to a printing process; however, the other known surface design processes such as coating, structuring, etc. are part of the idea of the invention. Within the scope of this description, we use the term “printing process” for the entirety of these visual surface design processes.

Any light that is reflected by a solar collector cannot be converted into electrical energy (in photovoltaics) or into thermal energy (in solar thermal energy technology). It is therefore of great importance to minimize the total amount of reflected light in the range of the energetically effective wavelengths by a suitable design of the printing processes, while still generating color and/or graphical patterns on the surface of the solar collector that are visually appealing to the human vision system.

In accordance with the invention, this is performed in a first embodiment thereof by an application of surface properties that reflect the incident sunlight only in a selected narrow-band wavelength range or in selected narrow-band wavelength ranges.

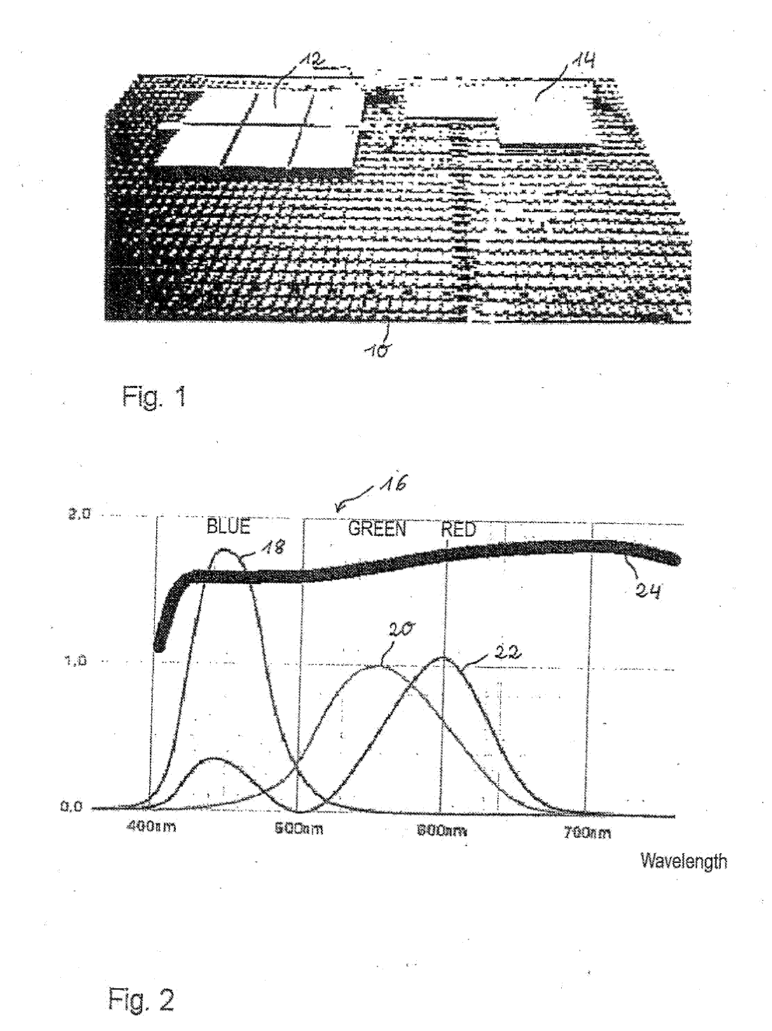

FIG. 2 shows in a graph 16 the relative spectral sensitivity of the color receptors of the human retina versus the wavelength. The human eye has three different types of cones acting as color receptors for the primary colors, BLUE, GREEN and RED. Their respective sensitivity is illustrated in the graph of FIG. 2. A line 18 shows the sensitivity of a blue cone, a line 20 shows the sensitivity of a green cone, and a line 22 shows the sensitivity of a red cone. The sensitivity curves correspond to spectral bandpasses in the range of the wavelengths of from about 400 nm to 650 nm, these bandpasses heavily overlapping in particular in the GREEN and RED regions. A curve 24 indicates the energetically effective absorption of the sunlight in this spectral region.

The knowledge of the sensitivity curves 18, 20 and 22 leads to a targeted selection of the pigments selected for the two-dimensional color printing on the surface of the solar collectors. For a blue impression, pigments are used that reflect in a very narrow band, near the maximum of the sensitivity of the blue cone of 435.6 nm, i.e., for example between about 430 and 445 nm. For a green impression, pigments are used that reflect in a very narrow band, near the maximum of the sensitivity of the green cone at 546.1 nm, i.e., for example between about 540 and 555 nm. For a red impression, pigments are used that reflect in a very narrow band, near the maximum of the sensitivity of the red cone at 600 nm, i.e., for example from about 590 to 605 nm.

This allows any desired color impression to be created in a human observer and, thus, also any desired impression of a three-dimensional spatial shape while, in comparison with traditional wide-band pigments, only small energetic losses occur. The radiation loss by reflection can therefore be kept very small, or, in other words, the energetic gain (1/loss) is substantial in comparison with the use of conventional, wide-band CMYK pigments (CMYK: cyan, magenta, yellow, key).

In accordance with the invention, in the second embodiment the desired visual color impression is achieved by application of surface properties which reflect the incident sunlight directionally selectively, with the radiation losses being as small as possible. In the embodiment described, the sunlight is reflected only into the limited solid angle or angles from which the solar collector mounted on the roof can typically be viewed by humans.

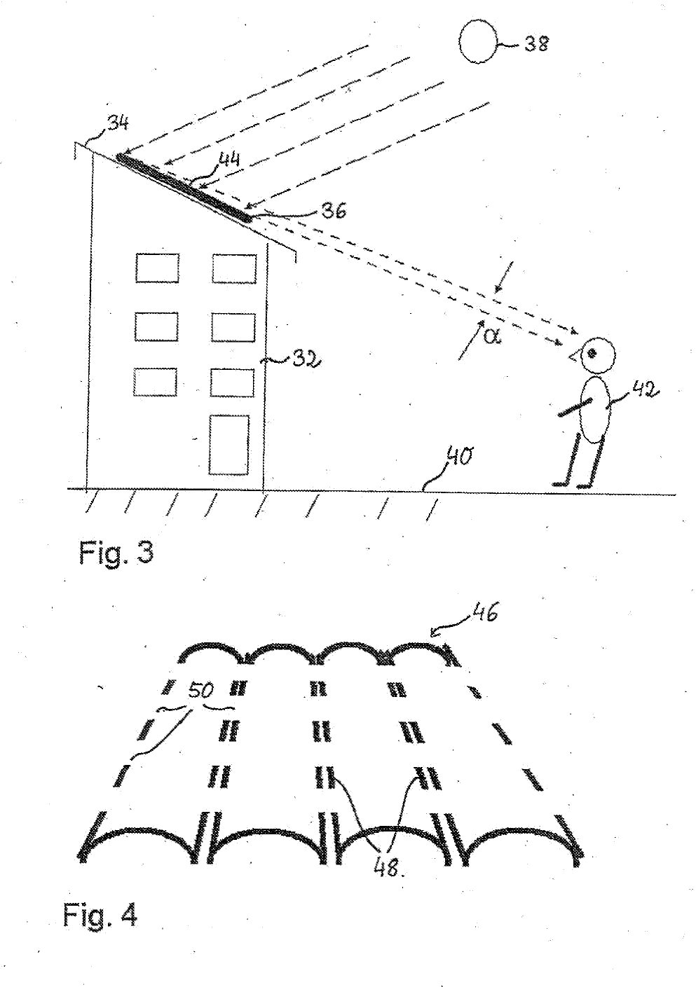

In this regard, FIG. 3 shows a building 32 with a slanted roof 34 having a solar collector 36 fitted thereon, which is illuminated substantially parallel by the sun 38, radiating from a large distance. Since a person 42 standing on a street 40 perceives the solar collector 36 as being compressed in perspective view, the angle that is applicable to the optical perception is reduced to a very small solid angle a, which amounts to only a fraction of the usual angle of diffuse reflection of a surface 44 of the solar collector 36 of about 180 degrees.

The surface is designed by a printing process (within the meaning of the above-mentioned generalization of the term “printing process”) such that incident sunlight is reflected only into the narrow solid angle from which the human observer 42 can see the solar collector 36. No light is reflected upwards or in other, lateral directions. The energetic efficiency hereby decreases roughly by approximately a fraction of a/180 degrees, compared with printing pigments reflecting diffusely into the entire half-space. Expressed in an equation:

ηᵣ=η₀−α/180*η₀

where ηᵣ=the resultant efficiency and η₀=the original efficiency.

At a typical value of α=10 degrees, this is a factor of 1/18, i.e., a small loss.

This second embodiment may, of course, be combined with the first.

The sunlight is reflected here such that the human observer 42 perceives a pattern corresponding to the surrounding surface, that is, in the illustrated case the pattern of a roof with roof tiles, i.e., a three-dimensional spatial shape, or else such that the human observer 42 perceives, for example, a work of art or an advertising message as an impression conveying contents. This form of sunlight reflection equally applies to the first embodiment.

FIG. 4 shows, for the third embodiment, an exemplary printing on the surface of a solar collector exposed to insolation, which may, of course, also be combined with the two embodiments already described above. The perceptive property of the human vision system to perceive interrupted graphical structures as not being interrupted is made use of here.

Therefore, a pattern 46 of a roof with roof tiles is printed on by a printing process as a graphical pattern with a reflective layer. The line-like structures 48 are interrupted time and again at points 50, so that the overall reflective surface is reduced corresponding to the ratio of line to interruption, without the human vision system being substantially disturbed in the recognition of a roof with roof tiles. Especially in the case of graphical structures drawn in perspective, lines that run into the vanishing point can be interrupted frequently and over substantial lengths without the impression of a closed roof tile pattern being lost. As a result, according to the invention the energetic efficiency increases roughly corresponding to the ratio of line section to interruption section, as compared with a pattern printed conventionally with non-interrupted lines.

It is known from color perception that specific color impressions can not only be influenced by the choice of the pigments, but also by the spatial frequencies of the line-like structures of a multicolor pattern (see, for example, EP 1 642 098 A1).

For this reason, the effects of perception of the line-like continuation and those of color perception, caused by the reflection on pigments reflecting in a narrow band, can be optimized in terms of energetics in that the appropriately interrupted, dense line-like structure and the pigments reflecting in a narrow band are combined with each other.

The idea of the invention relates both to photovoltaic and thermal solar collectors and comprises all processes for architectural, graphic, or color design of the absorbent surface of these solar collectors. It not only comprises the energetically optimized design in terms of an optical reconstruction of the building structures such as roof tiles or façade elements covered up by the solar collectors, which are in the form of, e.g., solar panels, or solar collectors installed outdoors and covering the ground. The term “architectural design” within the meaning of the idea of the invention also comprises the free artistic design and patterning with artistic motifs, but also with motifs in the sense of an advertising space or a message.

By way of summary, the idea of the invention relates to solar collectors and all manufacturing methods for the production of optically attractively patterned photovoltaic and thermal solar collectors such that, in comparison with a non-patterned solar collector, the energetic efficiency is only reduced to a small degree, this being achieved by a single or combined utilization of the following effects:
a) reflection essentially only into the limited solid angle from which the solar collector is viewed;
b) graphical design by line-like structures which are interrupted such that they do not disturb human perception as whole patterns;
c) colored two-dimensional design by pigments with narrow wavelength ranges in which a reflection occurs and which are within the range of the wavelengths perceptible by humans.

Although the invention has been described hereinabove with reference to a specific embodiment, it is not limited to this embodiment and no doubt further alternatives will occur to the skilled person that lie within the scope of the invention as claimed.

1-18. (canceled)

19. A solar collector having an absorbent surface that only reflects a small fraction of the sunlight and, said absorbent surface having selective reflection properties which simulate at least one of a plurality of two-dimensional surfaces and three-dimensional spatial shapes.

20. The solar collector according to claim 19, having an absorbent surface that reflects spectrally selectively.

21. The solar collector according to claim 20, wherein the spectrally selective reflection is formed or assisted by fluorescence.

22. The solar collector according to claim 21, having an absorbent surface that converts, by fluorescence, a part of the sunlight which is in the ultraviolet wavelength range into light that is visible to the human eye, and reflects it spectrally selectively.

23. The solar collector according to claim 19, having an absorbent surface that reflects directionally selectively.

24. The solar collector according to claim 19, having an absorbent surface that reflects surface-selectively.

25. The solar collector according to claim 19, wherein the absorbent surface reflects incident sunlight only in selected ones of narrow-band wavelength ranges which only have a width of about 5 to 15 nm each.

26. The solar collector according to claim 19, wherein the absorbent surface reflects incident sunlight in a narrow band in at least one wavelength range that corresponds to a high perception of the human eye.

27. The solar collector according to claim 23, wherein the absorbent surface is essentially not reflecting incident sunlight into a first solid angle range, reflecting incident sunlight into a second solid angle range which is smaller than the first solid angle range and essentially corresponds to that solid angle range at which the solar collector, when in an operative condition, is predominantly seen by a human observer.

28. The solar collector according to claim 27, wherein the first solid angle range is about fifteen to twenty times as large as the second solid angle range.

29. The solar collector according to claim 24, wherein the reflecting surfaces are interrupted such that a human observer does not perceive an interruption.

30. The solar collector according to claim 19, wherein the selective reflection properties are selected such that a human observer is given essentially the same visual impression of the solar collector as of the surface surrounding the solar collector in an operative condition.

31. The solar collector according to claim 19, wherein the selective reflection properties of the absorbent surface are realized by printing, coating or texturing.

32. The solar collector according to claim 19, wherein the solar collector comprises a glass plate that is printed, coated or textured.

33. The solar collector according to claim 19, wherein the solar collector comprises a plastic sheet or plastic film that is printed, coated or textured.

34. The solar collector according to claim 1, wherein the selective reflection properties of the absorbent surface are electronically controllable.

35. A method of manufacturing a solar collector for converting sunlight into thermal and/or electrical energy, wherein the reflection properties of the absorbent surface of the solar collector are selectively altered such that a three-dimensional spatial shape is simulated or a visual impression conveying contents is created.

36. The method according to claim 35, wherein the selective reflection properties of the absorbent surface are realized by printing, coating-or texturing.
